(19) United States
(12) Patent Application Publication
(10) Pub. No.: US 2005/0211797 A1
(43) Pub. Date: Sep. 29, 2005

(54) Fluid product dispenser

(76) Inventors: Aline Abergel, Boulogne-Billancourt (FR); Firmin Garcia, Evreux (FR)

Correspondence Address: SUGHRUE MION, PLLC, 2100 PENNSYLVANIA AVENUE, N.W., SUITE 800, WASHINGTON, DC, 20037, US

(21) Appl. No.: 10/497,652

(22) PCT Filed: Dec. 2, 2002
(86) PCT No.: PCT/FR02/04130

§ 371 Date: Jun. 4, 2004

(51) Int. Cl. B05B 1/08

(52) U.S. Cl. 239/333; 239/102.2

(57) ABSTRACT

A fluid dispenser comprising:
a fluid reservoir (2) provided with an opening (30); and
a dispenser member (61, 63) communicating with the opening of the reservoir in order to extract fluid, said dispenser member including a dispenser outlet (61) through which the fluid is dispensed while forming a dispensing spray adapted to hit a target, the dispenser being characterized in that it comprises detection means (7) that are capable of detecting at least one physical characteristic of the target on which the fluid is to be dispensed, said detector, on detecting said at least one physical characteristic of the target, then serving to trigger or influence the dispensing spray.

The present invention relates to a fluid dispenser comprising a reservoir designed to contain fluid, and a dispenser member that is mechanical, and preferably electromechanical. The dispenser member can be mounted on an opening of the reservoir, or in a variant, the dispenser member can merely communicate with the opening of the reservoir by means of a delivery duct for extracting fluid from the reservoir. As described in document EP-0 615 470 for example, this is an entirely conventional dispenser design, in which the dispenser member uses a perforated vibrator membrane that is advantageously driven by a piezoelectric element. Naturally, it is possible to envisage other dispenser-member systems which, for example, function by means of a vibrator system, e.g. by means of an electromagnet, which drives a vibrator membrane forming part of a dispenser chamber containing fluid. Such a dispenser is described, in particular, in document WO 01/34307.

In the two dispensers described in the above-mentioned prior-art documents, the electromechanical dispenser members are actuated by pressing on an actuator button. The actuator button loops the electrical circuit and thus powers the vibrator means. While electrically powered, the vibrator means cause the perforated membrane or the chamber membrane to vibrate in such a manner as to dispense a dose of fluid in the form of a dispensing spray which the user naturally directs towards a target so that the dispensing spray hits the target.

The object of the present invention is to influence actuation or the dispensing spray as a function of the target.

To achieve this object, the present invention provides detection means that are capable of detecting at least one physical characteristic of the target on which the fluid is to be dispensed, said detector, on detecting said at least one physical characteristic of the target, then serving to trigger or influence the dispensing spray. The detection means can, so to speak, serve as a “virtual” actuator button, or in a variant, the detection means can serve to modify the dispensing spray after pressing on an actuator button of the dispenser. In both cases, the detection means fulfill a similar purpose, namely that of influencing the functioning of the dispenser in response to a physical characteristic of the target coming into the detection field of the detection means.

In one embodiment, the physical characteristic is the distance between the dispenser outlet and the target. In this case, the detector means can trigger the dispensing spray. Additionally, or in a variant, the detection means can advantageously influence the shape of the dispensing spray as a function of the distance of the target. In addition, the detection means can advantageously influence the dispensing rate as a function of the distance to the target. The detection means can also influence the actuating frequency of the dispenser member.

It is thus possible to envisage a plurality of embodiments. In a simple embodiment, the detection means can serve merely to detect the presence of a target within a predetermined distance, e.g. from 5 centimeters (cm) to 30 cm, and in response to detecting the presence of the target, the detection means send an actuation signal which triggers the emission of a dispensing spray. In this simple case, the detection means merely replace a manual actuator button when the dispenser is placed in the vicinity of a target. In another case, the detection means can also serve to influence the general shape of the dispensing spray, e.g. by increasing or by decreasing its width or its diameter at the target. This type of detection means can be combined with a manual actuator button.

Naturally, the physical characteristic can also be selected from the group consisting of: the wetness of the target; the color of the target; the brightness of the target; the presence of a certain substance in the target; the content of a certain substance in the target; and the temperature of the target. By way of example, the detection means can detect a particular skin type, thereby enabling the rate at which the spray is dispensed to be adjusted, for a spray-on sun cream. By way of example, it is also possible to detect the wetness of hair in order to apply a hair care-product such as a conditioner. Applications are numerous and varied.

The invention is described in greater detail below with reference to the accompanying drawings, showing, by way of non-limiting example, an embodiment of the invention.

In the figures:

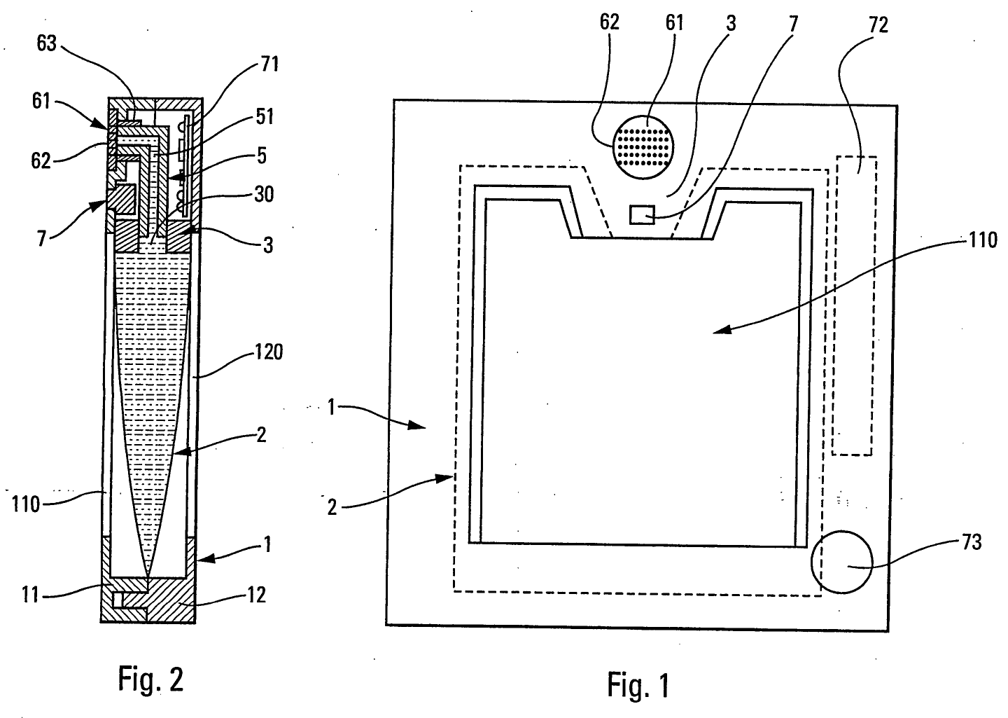

FIG. 1 is a front view of a dispenser made in accordance with the present invention, with some internal component elements of the dispenser being shown by dashed lines; and

FIG. 2 is a vertical cross-section view through the dispenser of FIG. 1.

With reference to the figures, the dispenser shown comprises a fluid reservoir 2 in the form of a deformable flexible pouch fixed on a pouch support piece 3 which defines an opening 30 for the reservoir. The characteristic of such a flexible pouch 2 is that it deforms by collapsing onto itself as the fluid is extracted therefrom through the opening 30. The flexible pouch 2 with its pouch support 3 is mounted in a rigid shell 1, which, in this case, is presented as two shell portions 11 and 12 fitted one on the other and fixed together by means of a fastening system. The bottom edge of the flexible pouch 2 is advantageously held between the two shell portions 11 and 12. In addition, the support piece 3 is held fast between the two shell portions 11 and 12. In this particular embodiment, each of the two shell portions 11 and 12 forms a respective open window 110 or 120 so that the walls of the flexible pouch 2 are visible at this location.

In this particular embodiment, the dispenser member is in the form of a vibrator membrane 61 perforated with an array of holes 62, as can be seen in FIG. 1. The membrane can be made of a deformable flexible material, while nevertheless presenting a certain degree of rigidity. The membrane can be made out of a very thin metal plate. To vibrate the perforated membrane 61, vibrator means 63 are provided which can be in the form of a piezoelectric element.

To deliver the fluid from the flexible pouch 2 onto the rear face of the perforated membrane 61, a delivery duct 5 is provided, connecting the membrane to the opening 30 of the support piece 3. The delivery duct 5 advantageously contains a capillary wick 51 which enables the fluid to be delivered by capillarity to the rear face of the perforated membrane 61. In this way, fluid is always present on the rear face of the perforated member 61, and, in addition, is at a pressure that is close to or slightly less than atmospheric pressure, which is preferable with such a perforated vibrator membrane.

With reference to FIG. 1, it can be seen that the shell 1 contains a housing for batteries 72, and an actuator button 73. By pressing on the pushbutton 73, the piezoelectric element 63 is powered, causing the vibrator member 61 to vibrate. As a result, fluid is dispensed in the form of a dispensing spray that the user directs towards a target so as to apply the fluid onto the target. Naturally, the target can be of very different types: it can be an article such as a blouse or a scarf, but it can also be the person's skin. It is even possible to envisage that the target is constituted merely by the air surrounding the dispenser. This applies to an air freshener or a humidifier.

In the invention, detection means 7 are provided that are capable of detecting at least one physical characteristic of the target on which the fluid is to be dispensed, said detector, on detecting the desired physical characteristic(s) of the target, then serving to trigger or influence the dispensing spray. By way of example, the detection means 7 can be in the form of a detection cell that is advantageously placed in the vicinity of the dispenser outlet, which, in this case, is in the form of the perforated vibrator membrane 61. In the example shown in the figures, the detection cell 7 is placed immediately beneath the vibrator member 61. The detection cell 7 is advantageously coupled to an integrated control circuit 71 which enables actuation of the dispenser to be triggered directly without pressing on the actuator button 73. The integrated control circuit 71 can also influence the dispensing spray, e.g. by modifying the shape of the spray, the dispensing rate of the spray, or even the frequency at which the dispenser member is actuated. Naturally, it is possible to envisage that the integrated control circuit 71 can influence other parameters of the dispenser. The integrated control circuit 71 thus triggers actuation and/or modifies the parameters of the dispensing spray in response to a signal delivered by the detection cell 7 once said detection cell has detected the desired physical characteristic of the target. In an embodiment, the physical characteristic of the target can quite simply be the distance between the target and the detection cell 7. The detection cell 7 can thus deliver the control signal to the integrated circuit 71 once a solid target is presented within a determined range in front of the detection cell 7. Only presence is detected, not distance, since the detection cell 7 sends the control signal as soon as a target is present in the range, which range can cover about 30 cm from the cell 7, for example. In a variant, the detection cell 7 can measure the distance between itself and the target, and can send a corresponding control signal to the control circuit 71. Thus, for varying distances between the cell and the target, the cell sends an appropriate control signal to the control circuit 71, which then influences the shape of the spray, or its dispensing rate, for example. It is also possible to envisage that the control circuit 71 has a memory integrated therein so that the dispensing spray is influenced by said circuit only after the actuator button 73 has been pressed, which button thus performs an entirely conventional role.

In addition or in a variant, the detection means can also detect other physical characteristics, e.g.: the wetness of the target; the color of the target; the brightness of the target; the presence of a certain substance in the target; the content of a certain substance in the target; and the temperature of the target. By way of example, it is possible to envisage that the detection cell 7 detects both the distance to the target and its wetness, and the integrated control circuit 71 influences the dispensing rate. It is also possible to envisage numerous other applications which depend greatly on the target to be reached. For example, the detection means 7 can merely measure the humidity of the surrounding air, and trigger dispensing of the fluid when its humidity drops below a certain level. In this case, the detection means serve merely as triggering means like a manual pushbutton, after measuring the humidity of ambient air.

In the embodiment described above, the dispenser is a portable or mobile spray that the user holds in one hand in order to move it towards the desired target. However, the present invention can be applied to fixed dispenser systems such as fixed promotional dispensers in perfume shops, or dispenser gates through which the target is moved. In this case, it is the target which is moved towards the dispenser.

The spirit of the invention resides in using various detection means for measuring or picking parameters specific to the target to be reached, so as to trigger or influence the functioning of a fluid dispenser.

1. A fluid dispenser comprising:
a fluid reservoir (2) provided with an opening (30); and
a dispenser member (61, 63) communicating with the opening of the reservoir in order to extract fluid, said dispenser member including a dispenser outlet (61) through which the fluid is dispensed while forming a dispensing spray adapted to hit a target, the dispenser being characterized in that it comprises detection means (7) that are capable of detecting at least one physical characteristic of the target on which the fluid is to be dispensed, said detector, on detecting said at least one physical characteristic of the target, then serving to trigger or influence the dispensing spray.

2. A dispenser according to claim 1, in which the physical characteristic is the distance between the dispenser outlet (61) and the target.

3. A dispenser according to claim 1, in which the detection means trigger the dispensing spray.

4. A dispenser according to claim 1, in which the detection means influence the shape of the dispensing spray.

5. A dispenser according to claim 1, in which the detection means influence the dispensing rate.

6. A dispenser according to claim 1, in which the detection means influence the actuating frequency of the dispenser member.

7. A dispenser according to claim 1, in which the physical characteristic is selected from the group consisting of:
the wetness of the target;
the color of the target;
the brightness of the target;
the presence of a certain substance in the target;
the content of a certain substance in the target; and
the temperature of the target.
